(19) United States
(12) Patent Application Publication
(10) Pub. No.: US 2012/0226544 A1
(43) Pub. Date: Sep. 6, 2012

(54) Method and system to create a proprietary social network that allow users to earn free points when they perform certain action on the social network. The method also deducts points when the user fails to perform certain task. The method allows users to accumulate points which convert to credits. The method and system allow users to use credits towards the purchase of special deals offered on the social network.

(76) Inventor: Alvin Merrifield, (US)

(21) Appl. No.: 13/041,414

(22) Filed: Mar. 6, 2011

(51) Int. Cl. G06Q 30/00

(52) U.S. Cl. 705/14.27

(57) ABSTRACT

The invention relates to a system an algorithm where people in a network earn virtual currency in the following manner; when they perform task and buy and trade currency in the network. The system use virtual currency to reduce the price of items for sale from merchants in the network. The invention automatically deducts from the purchase price the equivalent of virtual currency from the system and uses it to instantly reduce the price of items. The invention allows merchants to control the amount of currency that can be credit to each item individually. The invention provides a means where people can create their own savings and does not have to wait for discount sales.

A method and system to create a proprietary social network that allow users to earn free points when they perform certain action on the social network. The method also deducts points when the user fails to perform certain task. The method allows users to accumulate points which convert to credits. The method and system allow users to use credits towards the purchase of special deals offered on the social network.

### THE INVENTION

The invention is a method and system that let users of the social network earn free points automatically when they perform certain actions in the social network such as; check-in to their account, upload content and purchase special deals.

The invention is a method and system that deducts points automatically when users fail to perform certain task in the social network such as; check-in to account and when the user convert points to credits.

The invention is a method and system that allows users to accumulate points which is then converted to credits.

The invention is a method and system that give users a certain amount of free credits towards each purchase made on the social network.

The invention is a method and system that allow users to use a percentage of their credits towards the purchase of exclusive merchant deals on the social network.

### THE INVENTION SUMMARY

The invention is a social network concept designed around the idea of allowing people to conduct business in a social networking environment. The method and system begins by allowing users to earn free credit to use towards the purchase of special deals offered exclusively on the social network.

What is a claim?

Users join the social network and user information is stored in a central database in the social network. The social network database consist of the allowing key functions; login and profile information, a credit and debit points system, exclusive merchant deal offering and all the functions so a typical social network site such as, instant chat functions, wall posting and media content services.

1. In the social network the process automatically generates points to users when certain actions are performed. The system also automatically deducts points when certain tasks are not preformed. The process automatically converts points to credits once a certain amount of points are accumulated.

2. In the social network special deals are offered. The process automatically allows users to use credits towards the purchase of special deals offers on the social network.
1. In a social network, a method of processing certain actions performed by users to earn free points, when the users performs certain actions a request is sent to the server which validates the users, comprising: generating identification markers of records stored in a member database of the social network; receiving a request from the system that manages the database to identify relationship action performed by the user record in the database, the request including an identification marker of the action performed by the user; identifying the relationship information of the performed action having the identification marker in the user database of the social network by: (i) locating a record stored in the member database having an identification marker that matches the identification marker of the users preformed actions, and (ii) identifying records stored in the users database corresponding to action performed by the user; and crediting points to the users account.
2. In a social network, a method of processing users earn points to credits by sending a request to the server which validates the users earn points, comprising: generating identification markers of records stored in a member database of the social network; receiving a request from the system that manages the points database to verified accumulated points earn by the user record in the database, the request including an identification marker of the action performed by the user; identifying the relationship information of the verified points having the identification marker in the user database of the social network by: (i) locating a record stored in the member database having an identification marker that matches the identification marker of the users points, and (ii) identifying records stored in the users points database corresponding to action performed by the user; and adding the credits to the users account.
3. In a social network, a method of processing user's credits towards the purchase of special deals by sending a request to the server which validates the users credits, comprising: generating identification markers of records stored in a member database of the social network; receiving a request from the system that manages the credit database to verified accumulated credits earn by the user record in the database: (i) locating a record stored in the member database having an identification marker that matches the identification marker of the users credits, and (ii) identifying records stored in the users credit database corresponding to action performed by the user; and deducts the credit from users accounts.

The method comprising the following steps:
a) building an online social network consist of selection criteria;
b) design a customized social networking platform where users can earn points, shop for special deals, invite people, upload content and much more;
c) write a special algorithm code to manage points, credits and special offers;
d) create an automatic method that allow users to earn free points when they perform certain actions;
e) create an automatic method that allow the system to deduct points when users fail to perform certain actions;
f) create a system that let users convert points to credits;
g) create a system that allow users to use credits towards the purchase of special deals;
h) create a system that let users use their credit anywhere Visa is accepted;
i) design a social network website with special selection criteria;
j) allow users to log into the social network via the website and receive special selected criteria from users;
k) processing the user selection criteria;
l) activate users accounts;
m) provider users with a unique user identifier on the social network;
n) allow users to modified user accounts;
o) giving user access to manage account, earn points, buy special deals, sell products, communicate, wall posting, upload content, stream voice and video calls play games and much more;

### THE INVENTION MAIN BENEFITS

The invention is a social network where people earn free credit towards the purchase of special deals. Users earn credits when they; check-In, Upload Content, Invite Friends and Buy and Sell Products on the social network. The more people members link on the social network the more credit they will earn. People can redeem credits online;

1) Users get free credit to buy products on the social network

Users get to shop with free credits. Credits work like cash on the social network and can only be redeem towards the purchase of exclusive deals offered by selected merchants on the social network.

2) Users get exclusive offers from selected merchants

Users get to shop with members only exclusive offers from selected merchants. This offers are only available to members of the social network.

3) Users get all the benefits of a social network environment

Users get to conduct business in a social networking environment. User get access to free worldwide voice and video calls to other members, watch and list to video and music on-demand and enjoy all the functions of a social networking site such as; instant chat, play games and share content.

### THE INVENTION ABSTRACT

The invention relates to a method for creating a social networking website which integrates network servers, an online credit and debit system, a soft-witch and an exclusive merchant offering system. The method comprising: network servers, soft-switch, merchant system, credit and debit system and a website.

They system is designed with on-demand functions; everything is done right from the user browser so the user never have to download any software to make voice and video calls.

The social network servers are designed to offer all the functions of social networking. This includes media servers and database servers. The social network servers will create the back bone of the system allowing users to join, login, upload content, share information and connect with the people in their lives.

The soft-Switch network provides all the voice and video communication on the social network. This allows users to make free voice calls and stream live video group chat with friends and family from around the world. The switch is hosted on a server with constant internet connectivity and readies the social network server via an API. The switch handles all telecommunication networking process functions such as, call termination, call origination and voice mail and number provisioning.

The credit and debit system allow users to earn credits but also debit credits from users account. This works as a check and balance system. The credit and debit system also allow users to take advantage of our exclusive merchant deal offers by paying with credits.

The merchant system is a special deal program which merchants exclusively provide to members of the social network. We create a system where merchants get to sell their service to members at a big discount and still make a nice profit. We also create an environment where members get special offers and save lots of money. This creates a win-win for the merchant, the members and the system.

And the website is designed as a platform for users to sign-up and log into their accounts. The website provides users with full access to their accounts and all the functions of the social network.

Next; this method involves displaying information in a website, and receiving information place on the website.

Once users place information on the website the information is sent directly to the network. After receiving this information the network server processes the data. The network servers comprise selection criteria which can activate accounts and provides instant access to users.

Once the information provided on the website is verified the server then activates the user account and allows the user access to the social network.

Next; when users access the social network and performs a request, the social network will give users free points.

1. A method and a system to create a proprietary algorithm that instantly credit people in a network virtual currency when they perform certain actions.

ii. A method and a system to create a proprietary algorithm that automatically reduces the price of items for sale in a network using virtual currency.

iii. A method and a system to create a proprietary algorithm that let people in a network receive daily deals using virtual currency.

iiii. A method and a system to create a proprietary algorithm that let people in a network pay less for items by purchasing virtual currency lower the price.

v. A method and a system to create a proprietary algorithm that let merchants in a network offer discount savings on items to people in the network using virtual currency.
